(19) United States
(12) Patent Application Publication
(10) Pub. No.: US 2004/0240405 A1
(43) Pub. Date: Dec. 2, 2004

(54) Communication device and method, and recording medium

(75) Inventor: Jun Okazaki, Yokohama-shi (JP)

Correspondence Address: FOLEY & LARDNER, 2029 CENTURY PARK EAST, SUITE 3500, LOS ANGELES, CA, 90067

(73) Assignee: KABUSHIKI KAISHA TOSHIBA

(21) Appl. No.: 10/829,526

(22) Filed: Apr. 22, 2004

(30) Foreign Application Priority Data
May 30, 2003 (JP) 2003-155931

(51) Int. Cl. H04J 3/08

(52) U.S. Cl. 370/315; 370/351

(57) ABSTRACT

In the embodiment of the present invention, there is provided a communication device comprising a selection unit which selects one of a relay protocol designed to transmit the communication data to a receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth and is used to switch a protocol between the relay and direct protocols; and an interface unit which transmits the communication data in accordance with the protocol selected by the selection unit.

### CROSS-REFERENCE TO RELATED APPLICATIONS

This application is based upon and claims the benefit of priority from prior Japanese Patent Application No. 2003-155931, filed May 30, 2003, the entire contents of which are incorporated herein by reference.

### BACKGROUND OF THE INVENTION

1. Field of the Invention

The present invention relates to a communication device and method for transmitting communication data to a communication device on the receiving side, and a recording medium.

2. Description of the Related Art

In the Infrastructure mode of IEEE802.11 in a wireless network, communication data such as real-time data is sent from a transmitting-side communication device (sender) to a receiving-side communication device (receiver) via a control station (access point). Note that transmission of real-time data is characterized in that the communication bandwidth is occupied from the beginning to the end of a communication. Stream date, including video data, sound data, and the like are kinds of real-time data.

Upon transmitting real-time data in the Infrastructure mode, the communication bandwidth for an up-link (an upstream communication from the sender to the access point) and that for a down-link (a downstream communication from the access point to the receiver) are assured. Therefore, the Infrastructure mode requires a communication bandwidth twice that required to transmit real-time data itself.

On the other hand, in the Direct Link mode, the sender and receiver are directly connected to transmit data.

As a prior art of such technique, Jpn. Pat. Appln. KOKAI Publication No. 2001-45027 is known.

Upon transmitting real-time data in the Infrastructure mode, the communication bandwidths for communications in two directions, i.e., up- and down-links, are occupied. Therefore, the communication bandwidth occupied by real-time data often exceeds an allowable communication bandwidth (e.g., a maximum communication bandwidth) of the wireless network.

Also, due to a decrease in communication bandwidth upon change in modulation method in each of the up- and down-links, the communication bandwidth occupied by real-time data often exceeds an allowable communication bandwidth of the wireless network.

### BRIEF SUMMARY OF THE INVENTION

In the embodiment of the present invention, there is provided a communication device comprising a selection unit which selects one of a relay protocol designed to transmit the communication data to a receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth and is used to switch a protocol between the relay and direct protocols; and an interface unit which transmits the communication data in accordance with the protocol selected by the selection unit.

Embodiments of the invention may also be characterized as a communication method for transmitting communication data to a receiving-side communication device. The method includes selecting one of a relay protocol designed to transmit the communication data to the receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth used to transmit communication data; and transmitting the communication data in accordance with the selected protocol.

### BRIEF DESCRIPTION OF THE SEVERAL VIEWS OF THE DRAWING

FIG. 1 is a block diagram showing an example of the arrangement of a communication device according to the first embodiment of the present invention;

FIG. 2 is a flow chart showing an example of the operation of the communication device according to the first embodiment;

FIG. 3 is a block diagram showing an example of transmission of real-time data in the Infrastructure mode;

FIG. 4 is a block diagram showing an example of transmission of real-time data in the Direct Link mode;

FIG. 5 is a block diagram showing an example of the arrangement of a communication device according to the second embodiment of the present invention;

FIG. 6 is a flow chart showing an example of the operation of the communication device according to the second embodiment;

FIG. 7 is a block diagram showing an example of the arrangement of a communication device according to the third embodiment of the present invention;

FIG. 8 is a flow chart showing an example of the operation of the communication device according to the third embodiment;

FIG. 9 is a block diagram showing an example of the arrangement of a communication device according to the fourth embodiment of the present invention;

FIG. 10 is a flow chart showing an example of the operation of the communication device according to the fourth embodiment;

FIG. 11 is a block diagram showing an example of the arrangement of a communication device according to the fifth embodiment of the present invention;

FIG. 12 shows an example of the management state of communication bandwidths;

FIG. 13 is a flow chart showing an example of the operation of the communication device according to the fifth embodiment;

FIG. 14 is a block diagram showing an example of the arrangement of a communication device according to the sixth embodiment of the present invention;

FIG. 15 is a chart showing an example of the operation for acquiring an allowable communication bandwidth for a downstream communication;

FIG. 16 is a flow chart showing an example of the operation of the communication device according to the sixth embodiment; and

FIG. 17 is a list showing an example of conditions.

### DETAILED DESCRIPTION OF THE INVENTION

Preferred embodiments of the present invention will be described hereinafter with reference to the accompanying drawings.

The first to sixth embodiments to be described hereinafter clarify the switching condition between a protocol for transmitting communication data from a transmitting-side communication device (sender) to a receiving-side communication device (receiver) via a control station (access point), and a protocol for directly transmitting communication data from the sender to the receiver, thereby preventing the communication bandwidth of the network from falling below an acceptable bandwith for communication.

Note that the Infrastructure mode will be exemplified as a relay protocol, and the Direct Link mode will be exemplified as a direct protocol.

However, other modes such as an upgraded version of the Infrastructure mode and the like may be used as the relay protocol. Likewise, other modes such as an upgraded version of the Direct Link mode may be used as the direct protocol.

Also, a wireless network built using the IEEE802.11 standard or its extended standard will be exemplified. However, the same applies to other networks such as a wired network and the like.

As the extended standards of IEEE802.11, IEEE802.11a, IEEE802.11b, IEEE802.11e, and the like are available.

The same reference numerals denote the same parts throughout the accompanying drawings, and a detailed description thereof will be omitted.

(First Embodiment)

In this embodiment, upon detection of real-time data to be transmitted, the Direct Link mode is selected in place of the Infrastructure mode, and the Infrastructure mode is switched to the Direct Link mode.

FIG. 1 is a block diagram showing an example of the arrangement of a communication device according to this embodiment.

A network 1 comprises a plurality of communication devices 2a and 2b, and a control station (access point) 3. For example, the network 1 is a wireless LAN. In this embodiment, the communication device 2a will be explained as a wireless terminal on the transmitting side, and the communication device 2b will be explained as a wireless terminal on the receiving side.

The communication device 2a comprises a data processor 4, communication processor 5, detector 6, selector 7, wireless interface 8, and wireless communication antenna 28.

The data processor 4 executes processes such as conversion of communication data and the like, and provides communication data to the communication processor 5 and detector 6. For example, the data processor 4 compresses communication data to generate packet data.

The communication processor 5 executes processes such as appending of a header, appending of an error correction code, and the like to the communication data received from the data processor 4, and provides the processed communication data to the wireless interface 8.

The detector 6 detects real-time data from the communication data received from the data processor 4, and provides data indicating the detection result to the selector 7.

When the detector 6 detects real-time data, the selector 7 selects the Direct Link mode, and instructs the wireless interface 8 to make a data communication according to the Direct Link mode.

On the other hand, when the detector 6 does not detect any real-time data, the selector 7 selects the Infrastructure mode, and instructs the wireless interface 8 to make a data communication according to the Infrastructure mode.

The wireless interface 8 transmits the communication data received from the communication processor 5 in accordance with the mode designated by the selector 7.

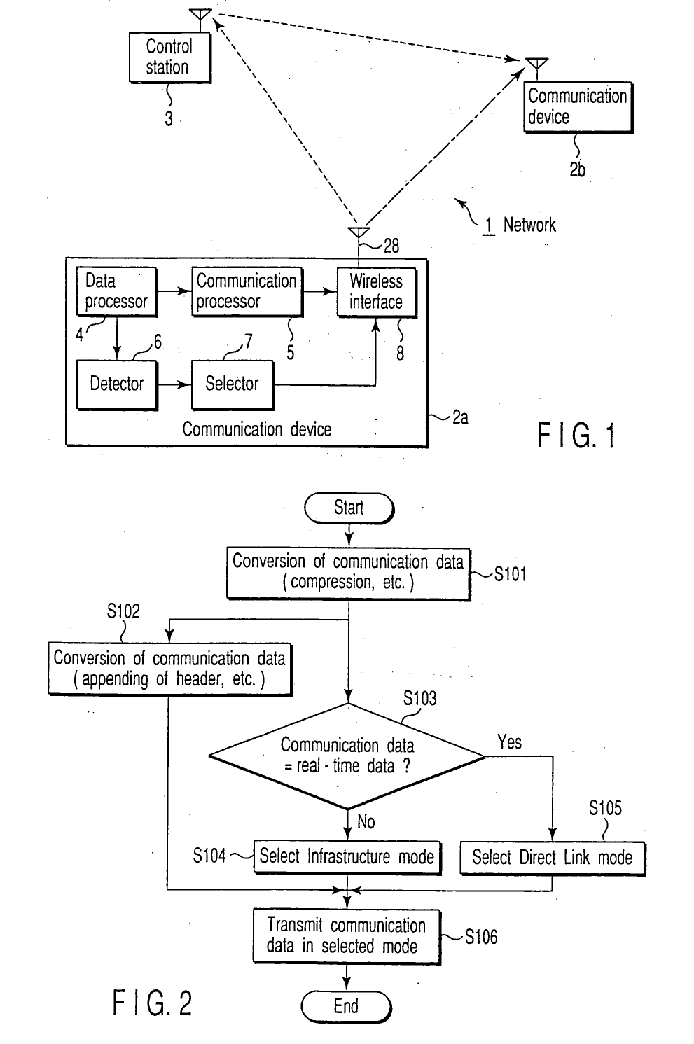

FIG. 2 is a flow chart showing an example of the operation of the communication device 2a according to this embodiment.

In step S101, the data processor 4 of the communication device 2a executes conversion such as compression and the like of communication data.

In step S102, the communication processor 5 executes conversion such as appending of a header and the like to the communication data.

The detector 6 checks in step S103 if the communication data is real-time data to detect real-time data. Examples of real-time date are MPEG2-TS (Transport System) packets and streaming data such as video and sound. Header information may be used to determine whether or not the data is real-time data.

If the communication data is not real-time data, the selector 7 selects the Infrastructure mode in step S104.

If the communication data is real-time data, the selector 7 selects the Direct Link mode in step S105.

In step S106, the wireless interface 8 transmits the communication data in accordance with the selected mode.

Note that the execution timing of step S102 above is not particularly limited as long as it is executed between steps S101 and S106.

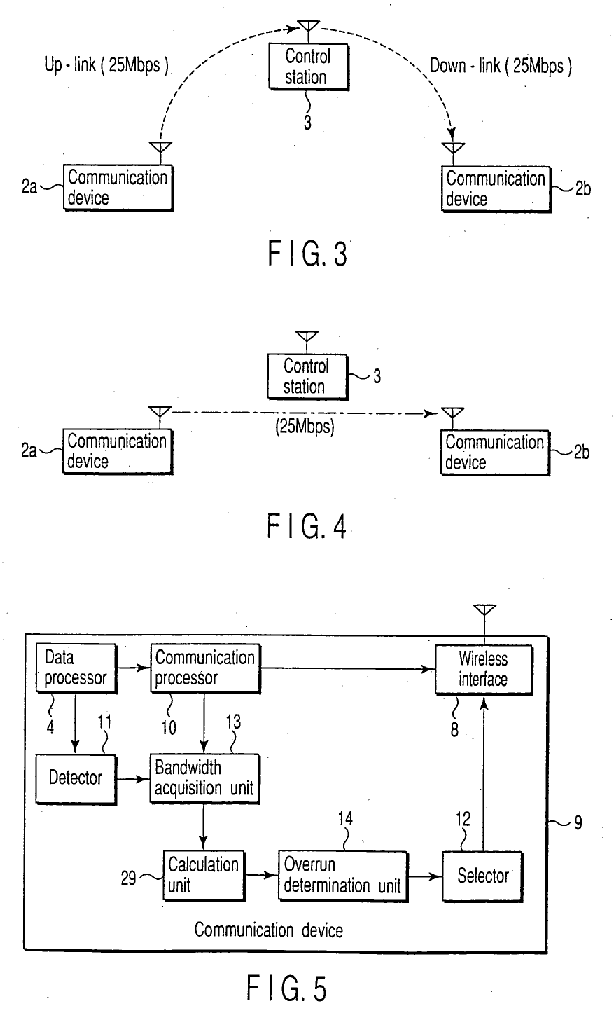

FIG. 3 is a block diagram showing an example of transmission of real-time data in the Infrastructure mode.

For example, assume that real-time data which occupies a 25-Mbps communication bandwidth is to be transmitted from the communication device 2a to the communication device 2b according to the Infrastructure mode.

In this case, both up- and down-links occupy communication bandwidths for transmitting real-time data, and simultaneously make data communications. As a result, a 50-Mbps communication bandwidth as the sum of the communication bandwidths for the up- and down-links is occupied to transmit the real-time data, and may exceed an allowable communication bandwidth of the network specified by IEEE802.11a.

FIG. 4 is a block diagram showing an example of transmission of real-time data in the Direct Link mode.

For example, when real-time data which occupies a 25-Mbps communication bandwidth is to be transmitted according to the Direct Link mode, the real-time data is directly transmitted from the communication device 2a to the communication device 2b. Therefore, since the real-time data can be transmitted by the 25-Mbps communication bandwidth, the communication bandwidth can be prevented from falling short of that required for communication.

In the communication device 2a according to the aforementioned embodiment, the Direct Link mode is selected when real-time data is detected, and the Infrastructure mode is selected when no real-time data is detected.

In this manner, this embodiment can automatically switch the protocol from the Infrastructure mode to the Direct Link mode upon transmission of real-time data.

Also, the communication bandwidth occupied by transmission of real-time data can be about half that required upon transmitting that data in the Infrastructure mode, i.e., the communication bandwidth required by the real-time data itself, and the communication bandwidth of the network 1 can be prevented from falling short, thus realizing high-band data transmission.

(Second Embodiment)

This embodiment is a modification of the first embodiment. In this embodiment, the total communication bandwidth occupied upon transmission of real-time data in the Infrastructure mode is calculated. When the calculated total communication bandwidth of the real-time data exceeds a threshold or other condition, the Direct Link mode is selected; when the threshold or other condition is not satisfied, the Infrastructure mode is selected.

FIG. 5 is a block diagram showing an example of the arrangement of a communication device according to this embodiment.

A communication device 9 on the transmitting side has an arrangement by adding a bandwidth acquisition unit 13, calculation unit 29, and overrun determination unit 14 to the communication device 2a in FIG. 1. Also, the communication device 9 on the transmitting side comprises a communication processor 10, detector 11, and selector 12 in place of the communication processor 5, detector 6, and selector 7 of the communication device 2a.

The detector 11 provides the detection result of real-time data to the bandwidth acquisition unit 13, and other features of the detector 11 are the same as those of the detector 6 in FIG. 1.

When the detector 11 detects real-time data, (e.g., using header information), the communication processor 10 acquires a bandwidth that communication data has as its property, and provides the bandwidth to the bandwidth acquisition unit 13. Other features of the communication processor 10 are the same as those of the communication processor 5 in FIG. 1.

When the detector 11 detects real-time data, the bandwidth acquisition unit 13 acquires a communication bandwidth occupied by transmission of the communication data from the communication processor 10, and provides the acquired communication bandwidth of the communication data to the calculation unit 29.

The calculation unit 29 doubles the communication bandwidth of the communication data to calculate the total communication bandwidth occupied by both up- and down-links, and provides the total communication bandwidth of the communication data to the overrun determination unit 14.

The overrun determination unit 14 determines whether or not the total communication bandwidth of the communication data satisfies a predetermined condition that defines a state wherein the total communication bandwidth exceeds an allowable communication bandwidth of the network, and provides data indicating the determination result to the selector 12.

For example, the overrun determination unit 14 determines whether or not the total communication bandwidth of the communication data exceeds a threshold or exceeds a predetermined ratio of the maximum allowable communication bandwidth of the network.

Alternatively, an allowable communication bandwidth that allows normal data communications in the Infrastructure mode may be obtained in advance by experiments, a statistical scheme, or the like. The overrun determination unit 14 may determine whether or not the total communication bandwidth of the communication data exceeds this allowable communication bandwidth.

When it is determined that the condition is not satisfied, i.e., the allowable communication bandwidth is not exceeded, the selector 12 selects the Infrastructure mode. On the other hand, when it is determined that the condition is satisfied, the selector 12 selects the Direct Link mode.

Note that the selector 12 may select the Infrastructure mode as a default mode, and may select the Direct Link mode when the overrun determination unit 14 determines that the condition is satisfied.

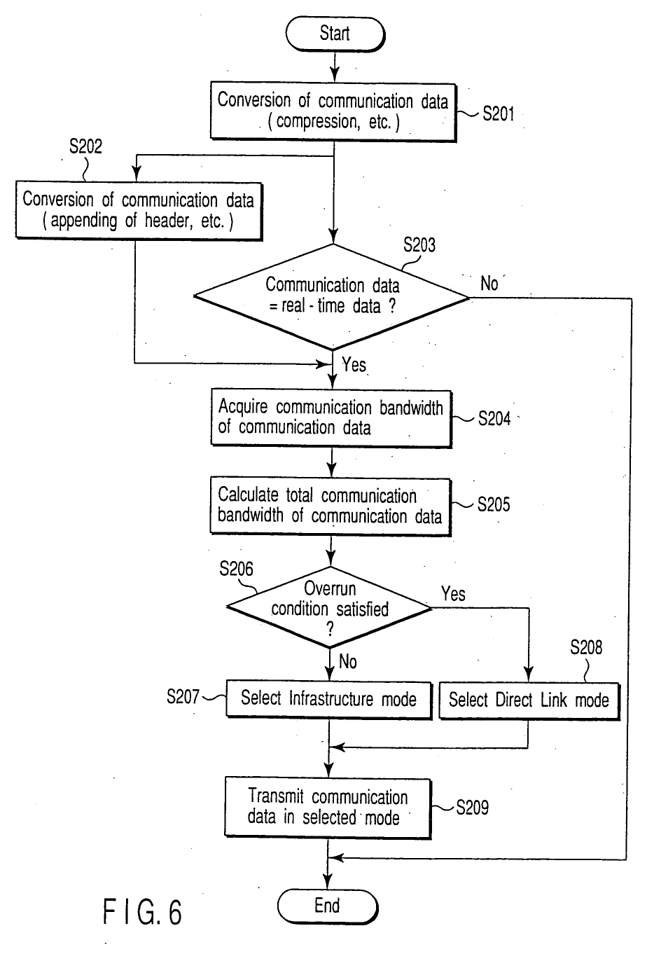

FIG. 6 is a flow chart showing an example of the operation of the communication device 9 according to this embodiment.

Step S201 is the same as step S101 in FIG. 2.

In step S202, the communication processor 10 acquires the communication bandwidth of communication data in addition to the same conversion process as that in step S101 in FIG. 2.

Step S203 is the same as step S103 in FIG. 2. However, if no real-time data is detected, the process ends, or step S203 is repeated.

If real-time data is detected, the bandwidth acquisition unit 13 acquires the communication bandwidth of the communication data in step S204.

In step S205, the calculation unit 29 calculates the total communication bandwidth of the communication data.

The overrun determination unit 14 determines in step S206 if the condition required to determine that the total communication bandwidth of the communication data exceeds the allowable communication bandwidth of the network is satisfied.

If the condition is not satisfied, the selector 12 selects the Infrastructure mode in step S207.

If the condition is satisfied, the selector 12 selects the Direct Link mode in step S208.

In step S209, the wireless interface 8 transmits the communication data in accordance with the selected mode.

Note that step S202 may be executed before, after, or parallel to step S203.

The aforementioned communication device 9 according to this embodiment switches the protocol between the Direct Link mode and the Infrastructure mode on the basis of the determination result indicating whether or not the condition required to determine that the total communication bandwidth of real-time data exceeds the allowable communication bandwidth of the network is satisfied.

For example, when communication data is real-time data which occupies a 10-Mbps communication bandwidth, a 20-Mbps communication bandwidth is occupied if that data is transmitted according to the Infrastructure mode. Since the 20-Mbps communication bandwidth falls within the allowable communication bandwidth of the network, real-time data can be transmitted according to the Infrastructure mode.

However, when communication data is real-time data which occupies a 25-Mbps communication bandwidth, a 50-Mbps communication bandwidth is occupied if that data is transmitted according to the Infrastructure mode. Although the allowable communication bandwidth of IEEE802.11a is 54 Mbps, a communication bandwidth that can be occupied in practice is about 30 odd Mbps due to an overhead caused by appending of a packet header and the like.

When the total communication bandwidth of real-time data exceeds the allowable communication bandwidth of the network in this way, this embodiment switches the protocol from the Infrastructure mode to the Direct Link mode.

In this way, efficient data communications can be attained, high-band transmission of real-time data can be realized, and the communication bandwidth of the network can be prevented from falling short of that required for communication.

(Third Embodiment)

This embodiment is a modification of the first and second embodiments. This embodiment acquires allowable communication bandwidths of up- and down-links in the Infrastructure mode. When at least one of a condition required to determine that the communication bandwidth of communication data exceeds the allowable communication bandwidth of the up-link and a condition required to determine that it exceeds the allowable communication bandwidth of the down-link is satisfied, the Direct Link mode is selected; when neither of the conditions are satisfied, the Infrastructure mode is selected.

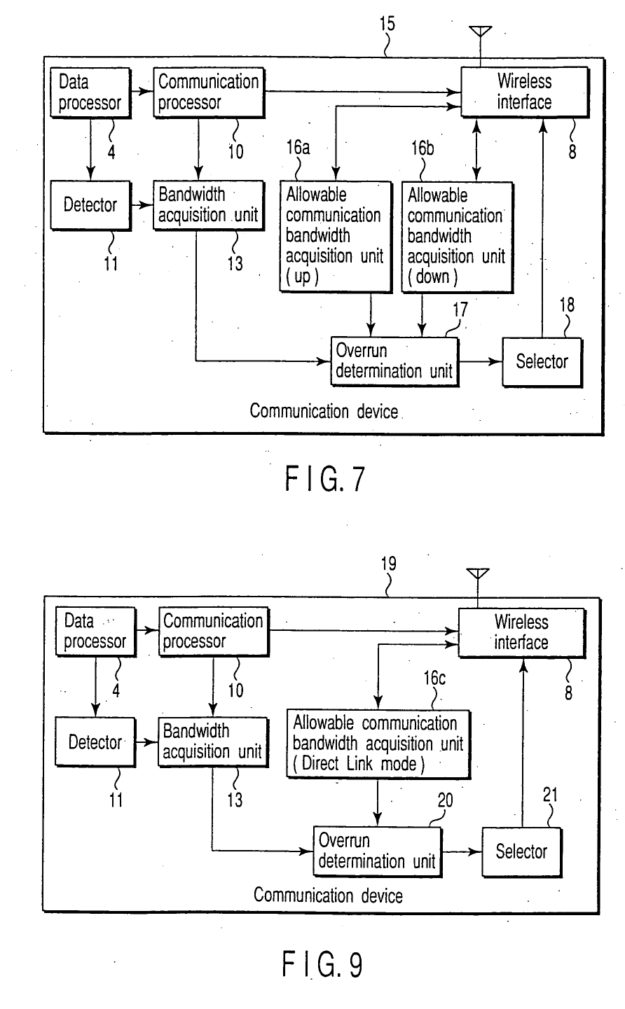

FIG. 7 is a block diagram showing an example of the arrangement of a communication device according to this embodiment.

A communication device 15 has an arrangement obtained by appending allowable communication bandwidth acquisition units 16a and 16b to the communication device 9 in FIG. 5, and excluding the calculation unit 29 from the communication device 9. The communication device 15 comprises an overrun determination unit 17 and selector 18 in place of the overrun determination unit 14 and selector 12 of the communication device 9 in FIG. 5.

The allowable communication bandwidth acquisition unit 16a acquires a communication bandwidth that can be currently occupied by the up-link in the Infrastructure mode, and provides the acquired communication bandwidth as an allowable communication bandwidth of the up-link to the overrun determination unit 17.

The allowable communication bandwidth acquisition unit 16b acquires a communication bandwidth that can be currently occupied by the down-link in the Infrastructure mode, and provides the acquired communication bandwidth as an allowable communication bandwidth of the down-link to the overrun determination unit 17. For example, the allowable communication bandwidth acquisition unit 16b inquires of the control station 3 of a communication bandwidth that can be occupied by the down-link, and receives an allowable communication bandwidth of the down-link as a response.

The overrun determination unit 17 determines whether or not the communication bandwidth of the communication data received from the bandwidth acquisition unit 13 satisfies a predetermined condition that defines a state wherein the communication bandwidth exceeds the allowable communication bandwidth of the up-link.

Likewise, the overrun determination unit 17 determines whether or not the communication bandwidth of the communication data satisfies a predetermined condition that defines a state wherein the communication bandwidth exceeds the allowable communication bandwidth of the down-link.

For example, the overrun determination unit 17 determines whether or not the communication bandwidth of the communication data exceeds a predetermined ratio of the allowable communication bandwidth of the up-link, and also whether or not it exceeds a predetermined ratio of the allowable communication bandwidth of the down-link.

When the overrun determination unit 17 determines that neither of the conditions are satisfied, the selector 18 selects the Infrastructure mode. On the other hand, when at least one condition is satisfied, the selector 18 selects the Direct Link mode.

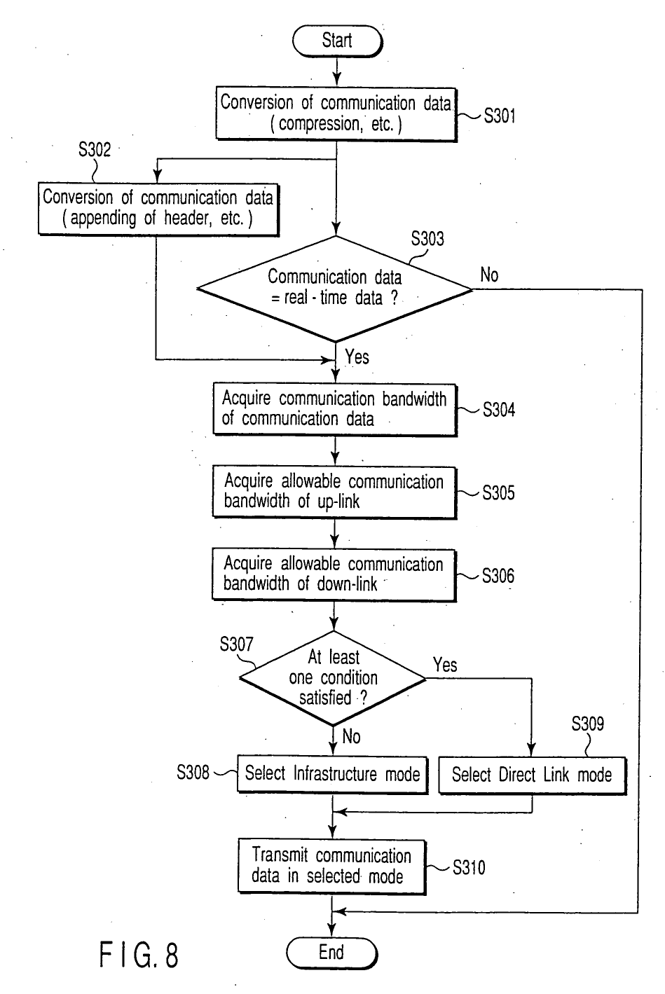

FIG. 8 is a flow chart showing the operation of the communication device 15 according to this embodiment.

Steps S301 to S304 are the same as steps S201 to S204 in FIG. 6. If no real-time data is detected in step S303, the process ends or step S303 is repeated.

In step S305, the allowable communication bandwidth acquisition unit 16a acquires the current allowable communication bandwidth of the up-link in the Infrastructure mode.

In step S306, the allowable communication bandwidth acquisition unit 16b acquires the current allowable communication bandwidth of the down-link in the Infrastructure mode.

The overrun determination unit 17 checks in step S307 whether or not at least one of the condition required to determine that the communication bandwidth of communication data exceeds the allowable communication bandwidth of the up-link, and the condition required to determine that it exceeds the allowable communication bandwidth of the down-link is satisfied.

If neither of the conditions are satisfied, the selector 18 selects the Infrastructure mode in step S308.

If at least one condition is satisfied, the selector 18 selects the Direct Link mode in step S309.

In step S310, the wireless interface 8 transmits the communication data in accordance with the selected mode.

Note that the execution order of steps S305 and S306 may be reversed, or these steps may be executed in parallel. Also, the execution timings of steps S305 and S306 are not particularly limited as long as they are executed between steps S301 to S307.

The aforementioned communication device 15 according to this embodiment determines whether or not the condition required to determine that the communication bandwidth of communication data exceeds the allowable communication bandwidth of the up-link is satisfied, and the condition required to determine that it exceeds the allowable communication bandwidth of the down-link is satisfied, and switches the protocol between the Infrastructure mode and the Direct Link mode on the basis of the determination result.

In IEEE802.11a and IEEE802.11b, the modulation method is changed from a bandwidth-priority mode to a reliability-priority mode when the wave condition is poor. Therefore, the allowable communication bandwidth of the down-link may become lower due to deterioration of the wave condition of the down-link.

Also, the communication bandwidth lowers with increasing communication distance. For this reason, the allowable communication bandwidth of the up- or down-link often lowers compared to the communication bandwidth of real-time data due to the communication distance of the up- or down-link.

However, in this embodiment, when the communication bandwidths of the up- and down-links have a margin, data is transmitted in the Infrastructure mode; when they do not have an enough margin, the protocol is switched from the Infrastructure mode to the Direct Link mode.

In this way, high-band transmission of real-time data can be realized, and the communication bandwidth can be prevented from falling short.

(Fourth Embodiment)

This embodiment is a modification of the first to third embodiments. In this embodiment, an allowable communication bandwidth of the Direct Link mode is acquired. If a condition required to determine that the communication bandwidth of communication data exceeds the allowable communication bandwidth of the Direct Link mode is satisfied, the Infrastructure mode is selected. In some situations, the maximum communication bandwidth of the Direct Link may be greater than that of the Infrastructure mode depending on the communication distances involved. For example, in the Infrastructure mode as shown in FIG. 3, the distance between the communication device 2a and the control station 3 is shorter than distances between the communications devices 2a and 2b in the Direct Link mode of FIG. 4. Thus, even with the doubling of the bandwidth for the up-link and down-link in the Infrastructure mode, the maximum communication bandwidth in the Infrastructure mode may still be lower than that of the Direct Link mode depending on the relative distances involved. As an example, when real-time data is being transmitted, to be sure that adequate bandwidth is available, this embodiment checks the available bandwidth for communication.

FIG. 9 is a block diagram showing an example of the arrangement of a communication device according to this embodiment.

A communication device 19 comprises an allowable communication bandwidth acquisition unit 16c in place of the allowable communication bandwidth acquisition units 16a and 16b, and also an overrun determination unit 20 and selector 21 in place of the overrun determination unit 17 and selector 18 in the communication device 15 in FIG. 7.

The allowable communication bandwidth acquisition unit 16c acquires a communication bandwidth that can be occupied by transmission in the Direct Link mode, and provides the acquired communication bandwidth as an allowable communication bandwidth of the Direct Link mode to the overrun determination unit 20.

The overrun determination unit 20 determines whether or not the total communication bandwidth of the communication data received from the bandwidth acquisition unit 13 satisfies a predetermined condition that defines a state wherein the communication bandwidth exceeds an allowable communication bandwidth of the Direct Link mode.

For example, the overrun determination unit 20 determines whether or not the communication bandwidth of communication data exceeds a predetermined ratio of the allowable communication bandwidth of the Direct Link mode.

If the condition is satisfied, the selector 21 selects the Infrastructure mode. On the other hand, when the condition is not satisfied, the selector 21 selects the Direct Link mode.

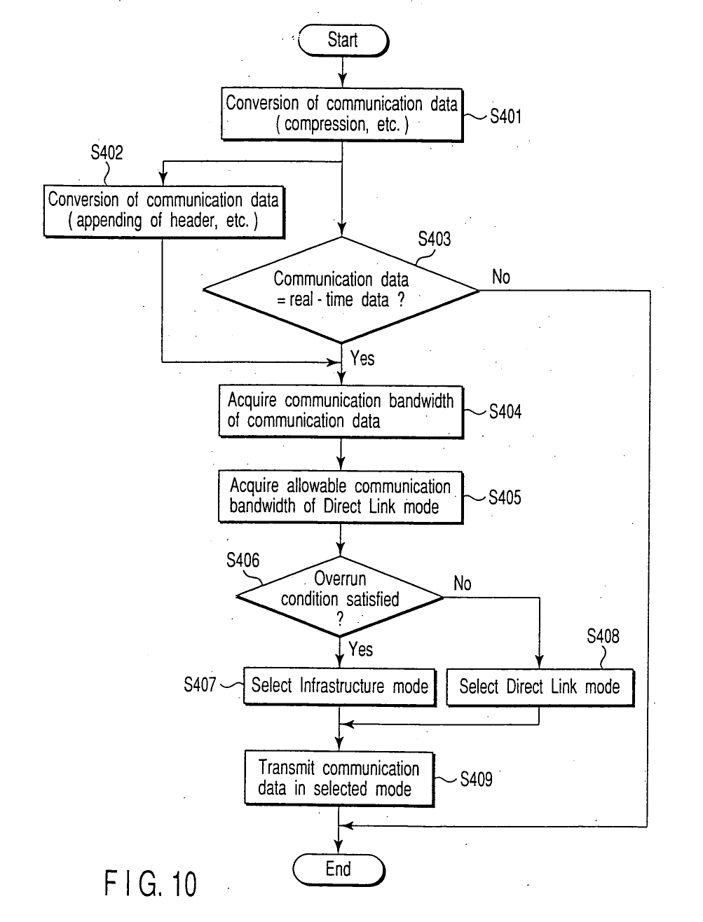

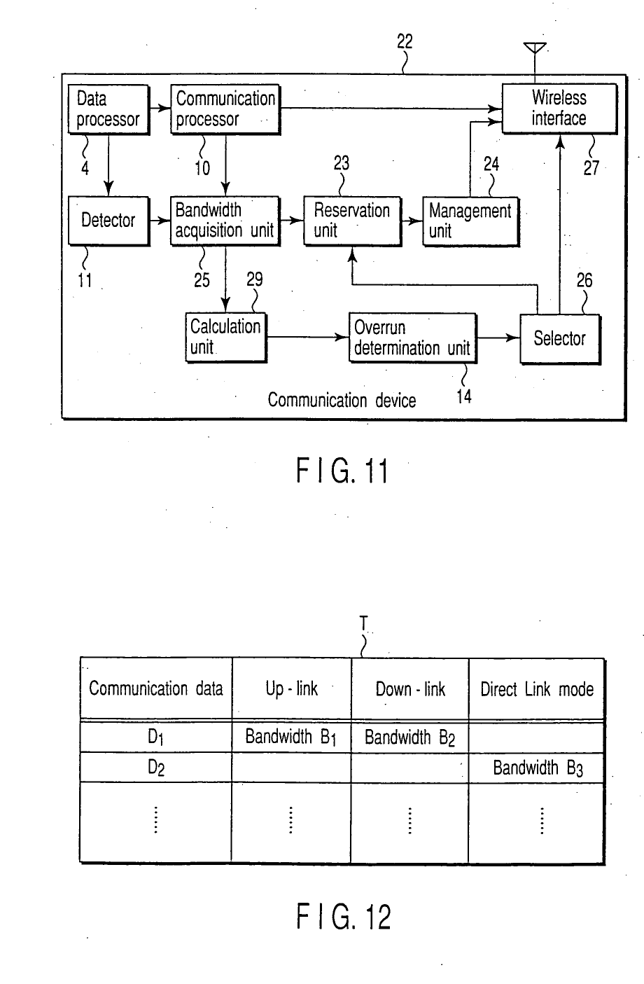

FIG. 10 is a flow chart showing an example of the operation of the communication device 19 according to this embodiment.

Steps S401 to S404 are the same as steps S301 to S304 in FIG. 8. If no real-time data is detected in step S403, the process ends or step S403 is repeated.

In step S405, the allowable communication bandwidth acquisition unit 16c acquires the current allowable communication bandwidth of the Direct Link mode.

The overrun determination unit 20 determines in step S406 whether or not the condition required to determine that the communication bandwidth of communication data exceeds the allowable communication bandwidth of the Direct Link mode is satisfied.

If the condition is satisfied, the selector 21 selects the Infrastructure mode in step S407.

If the condition is not satisfied, the selector 21 selects the Direct Link mode in step S408.

In step S409, the wireless interface 8 transmits communication data in accordance with the selected mode.

Note that the execution timing of step S405 is not particularly limited as long as it is executed between steps S401 to S406.

The aforementioned communication device 19 according to this embodiment selects the Infrastructure mode when the condition required to determine that the communication bandwidth of communication data exceeds the allowable communication bandwidth of the Direct Link mode is satisfied.

More specifically, in this embodiment, when the allowable communication bandwidth of the Direct Link mode is sufficiently broader than the communication bandwidth of communication data, and has a sufficient margin between the transmitting and receiving sides, data is transmitted in the Direct Link mode. Therefore, communication data can be transmitted more reliably.

(Fifth Embodiment)

This embodiment is a modification of the first to fourth embodiments. This embodiment manages the communication bandwidths of the up- and down-links in the Infrastructure mode, and that in the Direct Link mode. Note that a modification of the communication device 9 in the second embodiment will be explained below. Also, the communication devices 2a, 15, and 19 in other embodiments can be similarly modified.

FIG. 11 is a block diagram showing an example of the arrangement of a communication device according to this embodiment.

A communication device 22 has an arrangement by adding a reservation unit 23 and management unit 24 to the communication device 9 in FIG. 5, and comprises a bandwidth acquisition unit 25, selector 26, and wireless interface 27 in place of the bandwidth acquisition unit 13, selector 12, and wireless interface 8 of the communication device 9 in FIG. 5.

The bandwidth acquisition unit 25 provides the acquired communication bandwidth of communication data to the calculation unit 29 and reservation unit 23. Other features of the bandwidth acquisition unit 25 are the same as those of the bandwidth acquisition unit 13 in FIG. 5.

The selector 26 provides data indicating a selection instruction of the Direct Link mode to the reservation unit 23. Other features of the selector 26 are the same those of the selector 12 in FIG. 5.

The reservation unit 23 requests the management unit 24 to reserve the communication bandwidths of the up- and down-links of communication data on the basis of the communication bandwidth of the communication data received from the bandwidth acquisition unit 25.

Upon reception of the selection instruction of the Direct Link mode from the selector 26, the reservation unit 23 requests the management unit 24 to cancel the communication bandwidths of the up- and down-links reserved for the communication data, and to reserve the communication bandwidth of the Direct Link mode.

The management unit 24 manages the communication bandwidths of the up- and down-links for communication data in accordance with the reservation request for the up- and down-links from the reservation unit 23. Also, the management unit 24 cancels the communication bandwidths of the up- and down-links for communication data in accordance with the cancel request from the reservation unit 23. Furthermore, the management unit 24 manages the communication bandwidth of the Direct Link mode for communication data in accordance with the reservation request for the Direct Link mode from the reservation unit 23.

The wireless interface 27 transmits communication data received from the communication processor 10 in accordance with the mode designated by the selector 26. Note that the wireless interface 27 transmits communication data using the communication bandwidth which is managed by the management unit 24 and is reserved for that communication data.

FIG. 12 shows an example of the management state of communication bandwidths by the management unit 24.

The management unit 24 stores the identification number of communication data for which a communication bandwidth is reserved, and the identification number of the communication bandwidth reserved for that communication data in association with each other. For example, table T is used to manage the reserved communication bandwidths of the up- and down-links or the reserved communication bandwidth of the Direct Link mode for communication data.

Note that the management unit 24 may recognize a maximum allowable communication bandwidth of the network, and may manage the usable remaining bandwidth obtained by subtracting the communication bandwidth of communication data from the maximum allowable communication bandwidth.

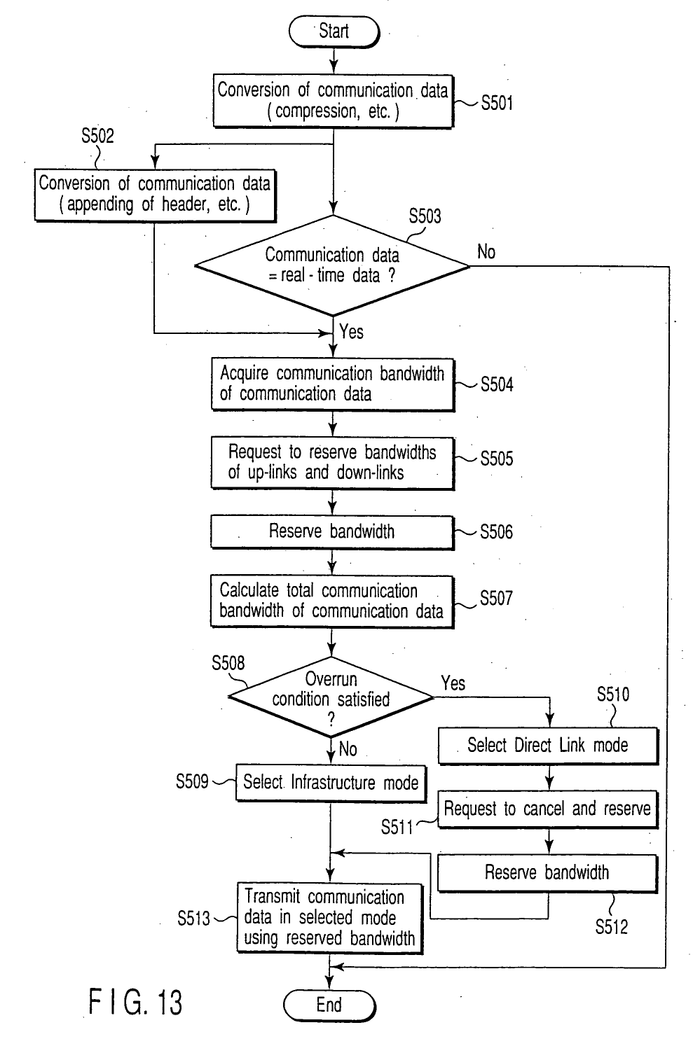

FIG. 13 is a flow chart showing an example of the operation of the communication device according to this embodiment.

Steps S501 to S504 are the same as steps S201 to S204 in FIG. 6. If no real-time data is detected in step S503, the process ends or step S503 is repeated.

In step S505, the reservation unit 23 requests the management unit 24 to reserve the communication bandwidths of the up- and down-links in the Infrastructure mode.

In step S506, the management unit 24 reserves and manages the communication bandwidths of the up- and down-links of communication data in accordance with the reservation request.

In step S507, the calculation unit 29 doubles the communication bandwidth of the communication data to calculate the total communication bandwidth of that communication data.

The overrun determination unit 14 determines in step S508 if the condition required to determine that the total communication bandwidth of the communication data exceeds the allowable communication bandwidth of the network is satisfied.

If the condition is not satisfied, the selector 26 selects the Infrastructure mode in step S509.

If the condition is satisfied, the selector 26 selects the Direct Link mode in step S510.

In step S511, the reservation unit 23 requests the management unit 24 to cancel the communication bandwidths of the up- and down-links reserved for the communication data, and to reserve the communication bandwidth of the Direct Link mode for the communication data.

In step S512, the management unit 24 cancels the communication bandwidths of the up- and down-links for the communication data, and reserves the communication bandwidth of the Direct Link mode for the communication data in accordance with the request from the reservation unit 23.

In step S513, the wireless interface 27 transmits the communication data in accordance with the selected mode using the reserved communication bandwidth.

In the aforementioned communication device 22 according to this embodiment, a communication bandwidth used to transmit communication data is reserved in advance.

Since the communication bandwidth is reserved and managed in this way, the communication bandwidth can be effectively managed in the network.

In each of the above embodiments, the functions of the building components of the communication device may be implemented by a program loaded onto a computer.

Also, the layout of the building components of the communication devices 2a, 9, 15, 19, and 22 according to the respective embodiments may be changed, the building components may be freely combined, the building components may be freely divided, or some building components may be omitted, as long as these building components can implement the same operations.

For example, the communication device 22 on the transmitting side comprises the management unit 24. Alternatively, another device such as the control station 3 or the like may comprise the management unit 24. The data processor 4 and communication processor 5 or 10 may be combined into a single building component.

Furthermore, various conditions in the above embodiments may be specified in consideration of the peak state of the communication bandwidth occupied by the network, the average occupied state of the communication bandwidth in the network, and the like.

(Sixth Embodiment)

This embodiment will explain a communication device as a combination of the second to fifth embodiments.

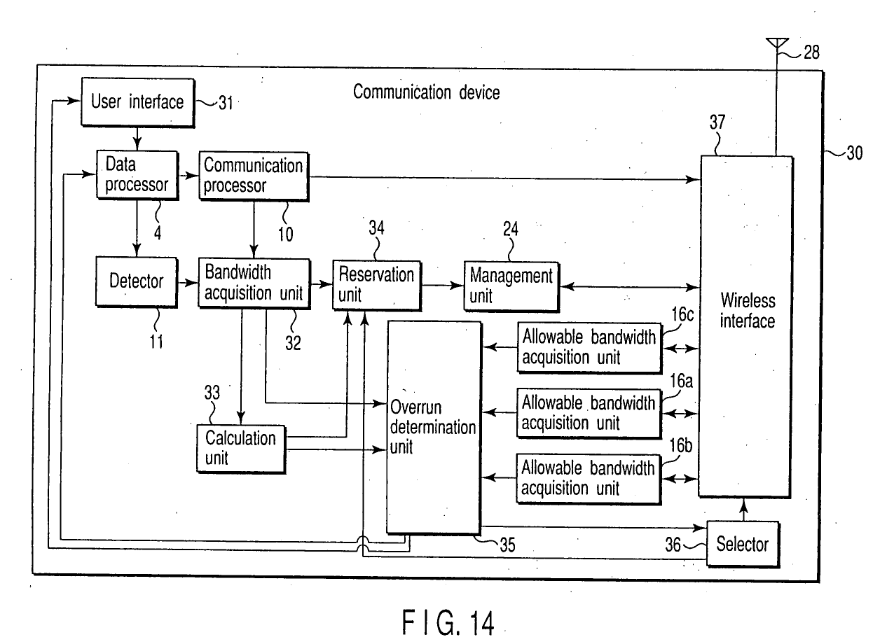

FIG. 14 is a block diagram showing an example of the arrangement of a communication device according to this embodiment.

This embodiment will exemplify IEEE802.11a and IEEE802.11e as wireless network protocols used to transmit real-time data. However, other protocols or standards may be applied as long as they are network protocols which can shift the network configuration using a control station (access point) to that which directly connects communication devices on the transmitting and receiving sides. Also, MPEG2-TS (Transport Stream) packets will be exemplified as real-time data. Furthermore, in this embodiment, the relationship among a communication device 30 on the transmitting side (sender), the control station 3, and the communication device 2b on the receiving side (receiver) is the same as that shown in FIGS. 1 to 3.

The communication device 30 comprises a user interface 31 which accepts user's operations.

The data processor 4 generates MPEG2-TS packets to be transmitted to the receiver 2b. More specifically, the data processor 4 executes an MPEG2 encoder process, an MPEG2-TS filter process in digital broadcast, and the like. Also, the data processor 4 comprises an analog or digital broadcast tuner.

The communication processor 10 reads a bandwidth that each MPEG2-TS packet received from the data processor has as its property from the description in, e.g., the MPEG2-TS packet, thus acquiring the bandwidth of the MPEG2-TS packets.

Note that the communication processor 10 may acquire a compression rate set in an MPEG2 encoder from a CPU (not shown) that controls the encoder, and may acquire the bandwidth of the MPEG2-TS packets.

Also, the communication processor 10 may select the bandwidth of a given program upon selection of that program on the basis of bandwidths which are determined in advance for respective programs in association with MPEG2-TS packets to be sent in digital broadcast, and may acquire the bandwidth of the MPEG2-TS packets.

The communication processor 10 adds a bandwidth which is increased in correspondence with a header or error correction code to be appended to the MPEG2-TS packets to the acquired bandwidth of the MPEG2-TS packet upon transmitting MPEG2-TS packets from the communication device 30 onto the wireless network, so as to acquire a communication bandwidth occupied by all the MPEG2-TS packets in the wireless network upon transmission. The communication processor 10 then provides the acquired communication bandwidth to a bandwidth acquisition unit 32 as that of the MPEG2-TS packets.

The header to be appended by the communication processor 10 varies depending on the wireless network protocols. For example, when IP (Internet Protocol), UDP (User Datagram Protocol), and RTP (Real-time Transport Protocol) are used, MPEG2-TS packets are encapsulated by headers of the respective protocols.

The detector 11 detects the presence/absence of MPEG2-TS packets to be sent to the receiver side of the wireless network.

Upon detection of MPEG2-TS packets, the bandwidth acquisition unit 32 acquires the communication bandwidth of MPEG2-TS packets from the communication processor 10, and provides the acquired communication bandwidth to a calculation unit 33 and overrun determination unit 35.

When the data processor 4 comprises an MPEG2 encoder, the communication bandwidth of MPEG2-TS packets acquired by the bandwidth acquisition unit 32 is a value obtained based on the data rate after MPEG2 encoding (compression). In case of digital broadcast, the communication bandwidth of MPEG2-TS packets acquired by the bandwidth acquisition unit 32 is a value of the communication bandwidth described in each MPEG2-TS packet, or a value obtained based on the bandwidth specified for each program.

The calculation unit 33 calculates the total communication bandwidth upon transmitting MPEG2-TS packets in the Infrastructure mode, and provides the total communication bandwidth of MPEG2-TS packets to the overrun determination unit 35 and a reservation unit 34. As described above, the up- and down-links occupy the same bandwidth. Hence, in case of MPEG2-TS packets having a bandwidth of 8 Mbps, the up- and down-links respectively occupy 8-Mbps bandwidths, and a total of 16-Mbps bandwidth is occupied in the wireless network.

The reservation unit 34 requests the management unit 24 to reserve the communication bandwidth or total communication bandwidth of MPEG2-TS packets in accordance with the selection result of a selector 36.

As described above, the management unit 24 may be implemented in another device of the wireless network in place of the communication device 30. In this case, the reservation unit 34 requests the management unit 24 in the other device to reserve the bandwidth via a wireless interface 37.

The management unit 24 manages the communication bandwidth of real-time data to be transmitted on the wireless network. For example, the management unit 24 discloses a total bandwidth that allows transmission in the wireless network to respective devices. When transmission of real-time data starts, the management unit 24 subtracts the communication bandwidth used to transmit that real-time data from the total bandwidth, and holds the remaining, unused communication bandwidth.

The allowable communication bandwidth acquisition unit 16c acquires an allowable communication bandwidth upon transmitting real-time data in the Direct Link mode.

More specifically, the allowable communication bandwidth acquisition unit 16c transmits a Probe Request of a Beacon frame specified by IEEE802.11 to the receiver, and acquires the allowable communication bandwidth using a response to that communication or a Probe Response. If the sender and receiver are distant from each other, it becomes difficult to receive data with a high wireless communication rate, and the allowable communication bandwidth acquisition unit 16c may not receive a response from the receiver 2b. If no response is received, the allowable communication bandwidth acquisition unit 16c lowers the wireless communication rate, and transmits data to the receiver 2b. The unit 16c repeats this process until it receives a response, and determines the rate at which the response is received as an allowable communication bandwidth.

As another allowable communication bandwidth acquisition method, the allowable communication bandwidth acquisition unit 16c may transmit test packets for bandwidth measurement in the Direct Link mode, and may acquire a value corresponding to the broadest bandwidth of the successfully transmitted test packets as the allowable communication bandwidth.

The allowable communication bandwidth acquisition unit 16a acquires the allowable communication bandwidth of the up-link. The allowable communication bandwidth of the up-link is acquired by a normal data communication between the sender 30 and control station 3. Note that the allowable communication bandwidth acquisition unit 16a may transmit test packets for bandwidth measurement to the control station 3, and may acquire a value corresponding to the broadest bandwidth of the successfully transmitted test packets as an allowable communication bandwidth.

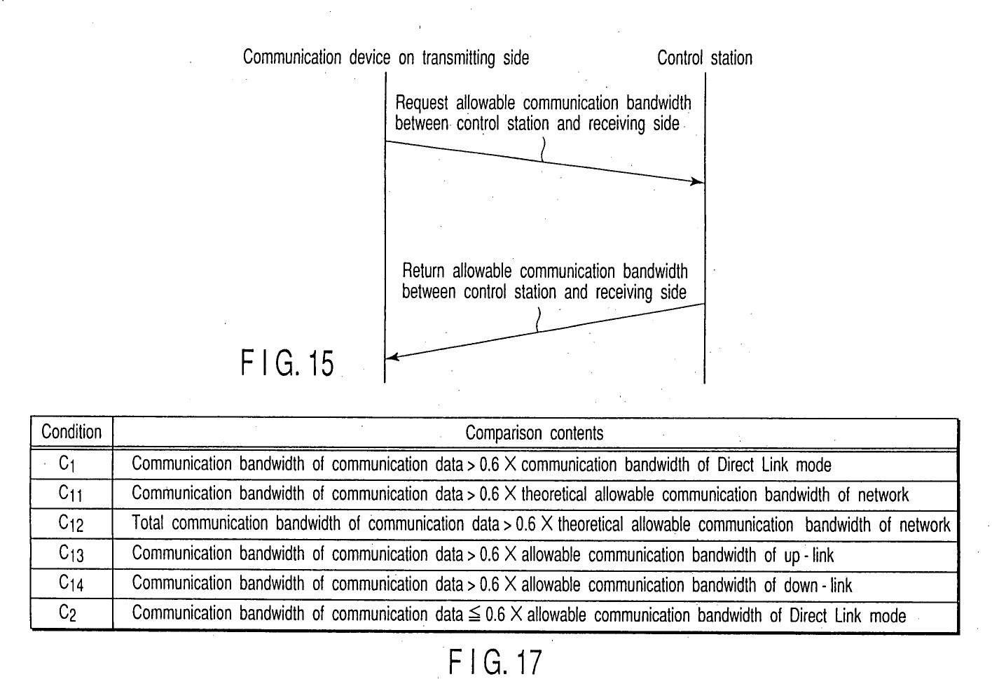

The allowable communication bandwidth acquisition unit 16b acquires the allowable communication bandwidth of the down-link. For example, if a data communication is made between the control station 3 and receiver 2b, the control station 3 has acquired the allowable communication bandwidth of the down-link. For this reason, as shown in FIG. 15, the allowable communication bandwidth acquisition unit 16b requests of the control station 3 the allowable communication bandwidth of the down-link. The control station 3 returns the allowable communication bandwidth of the down-link. The allowable communication bandwidth acquisition unit 16b then acquires the allowable communication bandwidth of the down-link. Upon reception of the allowable communication bandwidth request from the sender 30, the control station 3 may transmit test packets for bandwidth measurement to the receiver 2b, and may return a value corresponding to the broadest bandwidth of the successfully transmitted test packets as the allowable communication bandwidth.

The overrun determination unit 35 determines if various conditions are satisfied, by comparing a theoretical allowable communication bandwidth (a maximum communication rate of the wireless network on the standard), the allowable communication bandwidths received from the allowable communication bandwidth acquisition units 16a to 16c, the communication bandwidth of MPET2-TS packets received from the bandwidth acquisition unit 32, and the total communication bandwidth of MPET2-TS packets received from the calculation unit 33. The overrun determination unit 35 then provides the determination result to the selector 36.

The selector 36 instructs the wireless interface 37 to execute a process for shifting the wireless network from the Infrastructure mode to the Direct Link mode or a process for shifting the wireless network from the Direct Link mode to the Infrastructure mode on the basis of the determination result of the overrun determination unit 35.

When the Direct Link mode is selected, since the bandwidth occupied on the wireless network in the Direct Link mode is reduced compared to the Infrastructure mode, the selector 36 instructs the reservation unit 34 to reserve based on the reduced bandwidth.

The wireless interface 37 implements the physical layer and a part of the data link layer according to the wireless network standard. In this embodiment, IEEE802.11a using 5.2-GHz band is implemented as the physical layer, and the MAC (Medium Access Control) layer specified by expanding IEEE802.11 according to IEEE802.11e is implemented as the part of the data link layer.

The antenna 28 matches a radio wave used in IEEE802.11a.

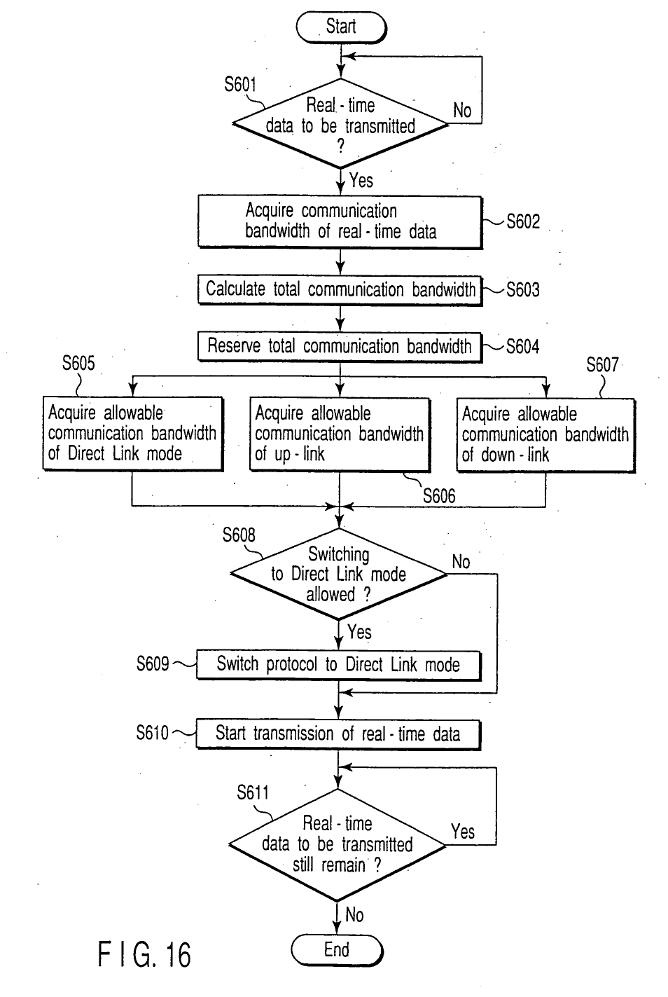

FIG. 16 is a flow chart showing an example of the operation of the communication device 30 according to this embodiment. FIG. 16 will explain a case wherein the communication device 30 comprises a digital broadcast tuner, multiplexes video and sound data output from that tuner, and transmits the multiplexed data as MPEG2-TS packets to the receiver 2b. The receiver 2b decodes the received MPEG2-TS packets, expands the received MPEG2-TS packets to video and sound signals, displays an image on, e.g., a liquid crystal display device, and outputs sound from a speaker. The control station 3 complies with IEEE802.11 and IEEE802.11e, and executes the process shown in FIG. 15.

The process in step S601 is executed by the user interface 31, data processor 4, and detector 11.

The user interface 31 accepts a digital broadcast program of user's choice to be output on the communication device 30.

The data processor 4 selects only MPEG2-TS packets of the program of user's choice from all MPEG2-TS packets received by its internal tuner, and provides the selected MPEG2-TS packets to the communication processor 10.

The detector 11 detects that preparation of the MPEG2-TS packets to be transmitted to the receiver 3b via the wireless network is complete in the data processor 4.

The detector 11 notifies the bandwidth acquisition unit 32 of starting of a wireless communication process for MPEG2-TS packets when the preparation of the MPEG2-TS packets to be transmitted is complete.

The flow then advances to step S602. If the detector 11 does not detect any MPEG2-TS packets to be transmitted, step S601 is repeated.

Step S602 is executed by the bandwidth acquisition unit 32 and communication processor 10.

The bandwidth acquisition unit 32 acquires the communication bandwidth of the MPEG2-TS packets to be transmitted from the communication processor 10, and provides that value to the calculation unit 33, reservation unit 34, and overrun determination unit 35. For example, assume that the communication bandwidth of MPEG2-TS packets is 25 Mbps.

Step S603 is executed by the calculation unit 33.

Since the Infrastructure mode is currently set in the wireless network, two-way communications, i.e., the up- and down-links, are required. Upon transmitting MPEG2-TS packets with the bandwidth of 25 Mbps to the receiver 2b via the control station 3, the up-link occupies a bandwidth of 25 Mbps, the down-link occupies a bandwidth of 25 Mbps, and the entire wireless network occupies a total communication bandwidth for 50 Mbps.

The calculation unit 33 provides the value “50 Mbps” obtained by doubling the communication bandwidth of the MPEG2-TS packets to the reservation unit 34 and overrun determination unit 35.

Step S604 is executed by the reservation unit 34 and management unit 24.

The reservation unit 34 declares to other devices that the total communication bandwidth of the MPEG2-TS packets is occupied in the wireless network, and requests the management unit 24 to make a reservation so as to confirm if the wireless network has a margin enough to occupy total communication bandwidth of the MPEG2-TS packets. The management unit 24 reserves a bandwidth according to the request from the reservation unit 34.

When the management unit 24 is implemented in another device on the wireless network in place of the communication device 30, the reservation unit 34 communicates with the device that implements the management unit 24 by sending an IEEE802.11 packet from the wireless interface 37 using a protocol or data structure required to reserve a communication bandwidth. As the protocol or data structure used to reserve the bandwidth, for example, a bandwidth reservation scheme for an Isochronous Resource Manager of IEEE1394 may be used.

If the management unit 24 determines that a sufficiently free bandwidth cannot be assured, it advises the reservation unit 34 accordingly. The reservation unit 34 informs the overrun determination unit 35 that the total communication bandwidth of the MPEG2-TS packets cannot be assured in the wireless network.

The process in step S605 is executed by the allowable communication bandwidth acquisition unit 16c and wireless interface 37.

The allowable communication bandwidth acquisition unit 16c acquires an allowable communication bandwidth used when the data communication protocol from the sender 30 to the server 2b shifts to the Direct Link mode.

In a wireless network complying with IEEE802.11, IEEE802.11a, and IEEE802.11b, devices having different maximum communication rates are often connected together. Also, a communication may be made using a lower wireless communication rate in place of the maximum communication rate due to causes such as a long distance between devices, the presence of any obstacle, and the like. For this reason, the allowable communication bandwidth between the sender 30 and receiver 2b is often lower than a theoretical value. Hence, the allowable communication bandwidth acquisition unit 16c acquires an actual allowable communication bandwidth of the Direct Link mode.

Step S606 is executed by the allowable communication bandwidth acquisition unit 16a and wireless interface 37.

The allowable communication bandwidth acquisition unit 16a transmits arbitrary data to the control station 3, and detects the presence/absence of a response from the control station 3, thus acquiring the allowable communication bandwidth of the up-link.

Step S607 is executed by the allowable communication bandwidth acquisition unit 16b and wireless interface 37.

The allowable communication bandwidth acquisition unit 16b requests of, e.g., the control station 3 the allowable communication bandwidth of the down-link. Upon reception of the request, the control station 3 returns the communication rate used in a communication with the receiver 2b as the allowable communication bandwidth of the down-link. The allowable communication bandwidth acquisition unit 16b acquires the allowable communication bandwidth of the down-link from the control station 3.

Step S608 is executed by the overrun determination unit 35.

The overrun determination unit 35 determines whether or not various conditions shown in FIG. 17 are satisfied, by comparing communication bandwidth B1 of MPEG2-TS packets, total communication bandwidth B2 of MPEG2-TS packets, allowable communication bandwidth B3 of the Direct Link mode, allowable communication bandwidth B4 of the up-link, allowable communication bandwidth B5 of the down-link, and theoretical allowable communication bandwidth B6 of the wireless network.

The comparison contents will be described below.

Bandwidths B3 to B5 acquired in steps S605 to S607 are communication rates derived from different modulation schemes specified by IEEE802.11a. The communication rates derived from different modulation schemes specified by IEEE802.11a includes eight different communication rates ranging from 6 Mbps to 54 Mbps. The bandwidths B3 to B5 are one of the eight different communication rates. For example, when the communication condition between the sender 30 and receiver 2b is very good, and a communication can be made by the 64QAM modulation scheme, bandwidth B3 assumes a value “54 Mbps”. On the other hand, when the communication condition between the sender 30 and receiver 2b is not so good due to a long distance between the sender 30 and receiver 2b, the influence of any obstacle, and the like, a communication must be made using the 16QAM modulation scheme, and bandwidth B3 assumes a value “24 Mbps”.

Since the maximum communication rate may be different depending on devices, bandwidth B4 assumes a minimum value of the maximum communication rates that the sender 30, control station 3, and receiver 2b can cope with. The maximum communication rates of the respective devices are acquired by exchanging, e.g., the Probe Request of the Beacon frame and the Probe Response in IEEE802.11.

On the other hand, bandwidths B1 and B2 acquired in steps S602 and S603 are acquired from the communication bandwidth of the MPEG2-TS packets to be transmitted. Communication data is appended with various headers upon transmitting on the wireless network. The wireless communication standard defines a period in which no data is to be transmitted, a period for synchronization, and the like. For this reason, the full communication rate cannot be used to transmit MPEG2-TS packets. A communication rate that can be used to transmit MPEG2-TS packets is normally about 60% of the maximum communication rate. Therefore, in the following description of this embodiment, assume that the communication rate that can be used to transmit MPEG2-TS packets is 60% of the maximum communication rate.

FIG. 17 shows an example of conditions according to the aforementioned conditions. Note that a weighting coefficient “0.6” in conditions C1, C11 to C14, and C2 can be changed as needed in correspondence with the nature of data to be transmitted and the network.

Condition C1 is “bandwidth B1>0.6×bandwidth B3”. This condition C1 is used to determine a state wherein the communication condition between the sender 30 and receiver 2b is poor due to, e.g., a long distance between the sender 30 and receiver 2b, and the allowable communication bandwidth of the Direct Link mode is smaller than the communication bandwidth of the MPEG2-TS packets.

If condition C1 is satisfied, since a sufficient bandwidth required to transmit the MPEG2-TS packet cannot be assured even when the Direct Link mode is selected, the flow advances to step S610 to select the Infrastructure mode.

If at least one of conditions C11 to C14 is satisfied, and it is determined that a sufficient bandwidth cannot be assured even in the Infrastructure mode, this means that the current wireless network cannot transmit the MPEG2-TS packets.

Therefore, if at least one of conditions C11 to C14 is satisfied, the overrun determination unit 35 informs the user that a communication cannot be made using the user interface 31. When the data processor 4 comprises an MPEG2 encoder, the overrun determination unit 35 determines that the current bandwidth of the MPEG2-TS packets is too high, and instructs to increase the compression ratio of the encoder and to lower the bandwidth of the MPEG2-TS packets.

Condition C11 is “bandwidth B1>0.6×bandwidth B6”. If this condition C11 is satisfied, it is determined that the communication bandwidth of communication data exceeds the allowable communication bandwidth of the wireless network.

Condition C12 is “bandwidth B2>0.6×bandwidth B6”. If this condition C12 is satisfied, it is determined that the total communication bandwidth occupied by both the up- and down-links in the Infrastructure mode exceeds the allowable communication bandwidth of the wireless network.

Condition C13 is “bandwidth B1>0.6×bandwidth B4”. If this condition C13 is satisfied, it is determined that the state of the up-link is bad, and a sufficient bandwidth required to transmit MPEG2-TS packets cannot be assured.

Condition C14 is “bandwidth B1>0.6×bandwidth B5”. If this condition C14 is satisfied, it is determined that the state of the down-link is bad, and a sufficient bandwidth required to transmit MPEG2-TS packets cannot be assured.

Condition C2 is “bandwidth B1<0.6×bandwidth B3”. If this condition C2 is satisfied, it is determined that the protocol can be switched from the Infrastructure mode to the Direct Link mode, and the flow advances to step S609. Condition C2 is an essential condition required to provide a mode switching instruction from the selector 36 to the wireless interface 37.

If the overrun determination unit 35 determines that condition C2 is satisfied, the flow may advance to step S609; if at least one of conditions C11 to C14 is satisfied, the flow may advance to step S609. As has been explained in step S604, if the bandwidth cannot be reserved based on the value of the total communication bandwidth of the MPEG2-TS packets, the flow may advance to step S609.

For example, assume that bandwidth B1=25 Mbps, bandwidth B2=50 Mbps, and bandwidth B3=bandwidth B4=bandwidth B5=bandwidth B6=54 Mbps. In this case, since condition C2 is satisfied but condition C12 is not satisfied, it is determined that a communication in the Direct Link mode can be made. This determination result is sent from the overrun determination unit 35 to the selector 36.

Step S609 is executed by the selector 36, wireless interface 37, and reservation unit 34.

The selector 36 selects a mode on the basis of the determination result of the overrun determination unit 35. If the Direct Link mode is selected, the selector 36 instructs the wireless interface 37 to execute a procedure and exchange a data required to switch the protocol to the Direct Link mode with the control station 3 and receiver 2b. As the contents of the procedure and data required for switching, for example, Direct Link Protocol described in IEEE802.11e is used.

The wireless interface 37 changes the destination of packets stored in each MPEG2-TS packet from the control station 3 to the receiver 2b.

Furthermore, the selector 36 instructs the reservation unit 34 to change the reserved total communication bandwidth of the MPEG2-TS packets to the communication bandwidth of the MPEG2-TS packets to be occupied upon transmission in the Direct Link mode.

Step S610 is executed by the communication processor 10 and wireless interface 37.

The communication processor 10 provides the MPEG2-TS packets, which have undergone processes such as appending of required headers, appending of an error correction code, and the like to the wireless interface 37.

The wireless interface 37 appends a MAC header complying with IEEE802.11 or IEEE802.11e, and transmits the packets to the receiver 2b in the mode determined in step S608 or S609.

Step S611 is executed by the user interface 31, data processor 4, detector 11, bandwidth acquisition unit 32, and reservation unit 34.

If the user interface 31 receives an abort instruction of real-time data transmission from the user, the data processor 4 aborts generation and output of MPEG2-TS packets.

If the detector 11 detects an output abort instruction of MPEG2-TS packets or an abort instruction from the user interface 31, the detector 11 informs the bandwidth acquisition unit 32 that the wireless communication process of the MPEG2-TS packet is aborted.

Upon reception of the abort message, the bandwidth acquisition unit 32 aborts acquisition of the communication bandwidth of MPEG2-TS packet, and sends a transmission abort message to the reservation unit 34.

The reservation unit 34 requests the management unit 24 to release the reserved bandwidth.

Note that the user interface 31 also sends an abort message to the selector 36. If the Direct Link mode is selected, the selector 36 may return the mode to the Infrastructure mode.

If MPEG2-TS packets to be transmitted still remain, step S611 is repeated.

In this embodiment described above, if the Infrastructure mode of IEEE802.11 is selected, MPEG2-TS packets are transmitted to the receiver 2b via the control station 3.

The bandwidth required to transmit MPEG2-TS packets in the Infrastructure mode is twice that required to transmit data itself. When the bandwidth falls short, if data is transmitted via the control station 3, the protocol is switched from the Infrastructure mode to the Direct Link mode to transmit data. In this way, real-time data with a large bandwidth can be smoothly transmitted.

If the allowable communication bandwidth of at least one of the up- and down-links is lower than the communication bandwidth of MPEG2-TS packets due to, e.g., a communication distance or the like, the protocol is switched from the Infrastructure mode to the Direct Link mode to assure a sufficient bandwidth. Then, the sender 30 can transmit MPEG2-TS packets to the receiver 2b.

What is claimed is:

1. A communication device comprising:
a selection unit which selects one of a relay protocol designed to transmit the communication data to a receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth and is used to switch a protocol between the relay and direct protocols; and
an interface unit which transmits the communication data in accordance with the protocol selected by the selection unit.

2. A device according to claim 1, further comprising:
a unit which detects real-time data to be transmitted to the receiving-side communication device, and
wherein the selection unit selects the relay protocol when the real-time data is not detected, and selects the direct protocol when the real-time data is detected.

3. A device according to claim 1, further comprising:
a unit which acquires a communication bandwidth of the communication data;
a unit which calculates a total communication bandwidth required upon transmitting the communication data in accordance with the relay protocol on the basis of the communication bandwidth of the communication data; and
a unit which determines whether or not the total communication bandwidth satisfies a condition that defines a state in which the total communication bandwidth exceeds an allowable communication bandwidth of a network used to transmit the communication data, and
wherein the selection unit selects the relay protocol when the condition is not satisfied, and selects the direct protocol when the condition is satisfied.

4. A device according to claim 1, further comprising:
a unit which acquires a communication bandwidth of the communication data;
a first acquisition unit which acquires an allowable communication bandwidth to the control station based on the relay protocol;
a second acquisition unit which acquires an allowable communication bandwidth from the control station to the receiving-side communication device based on the relay protocol; and
a unit which determines whether or not the communication bandwidth of the communication data satisfies a first condition that defines a state in which the communication bandwidth exceeds the allowable communication bandwidth to the control station, and whether or not the communication bandwidth of the communication data satisfies a second condition that defines a state in which the communication bandwidth exceeds the allowable communication bandwidth from the control station to the receiving-side communication device, and
wherein the selection unit selects the relay unit when neither of the first and second conditions are satisfied, and selects the direct protocol when at least one of the first and second conditions is satisfied.

5. A device according to claim 1, further comprising:
a unit which acquires a communication bandwidth of the communication data;
a unit which acquires an allowable communication bandwidth based on the direct protocol; and
a unit which determines whether or not the communication bandwidth of the communication data satisfies a condition that defines a state in which the communication bandwidth exceeds the allowable communication bandwidth based on the direct protocol, and
wherein the selection unit selects the direct protocol when the condition is not satisfied, and selects the relay protocol when the condition is satisfied.

6. A device according to claim 1, further comprising:
a unit which reserves a communication bandwidth required to transmit the communication data in accordance with the relay protocol, and cancels the reserved communication bandwidth and reserves a communication bandwidth required to transmit the communication data in accordance with the direct protocol when the selection unit selects the direct protocol, and
wherein the interface unit transmits the communication data using the reserved communication bandwidth.

7. A communication method for transmitting communication data to a receiving-side communication device, comprising:
selecting one of a relay protocol designed to transmit the communication data to the receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth used to transmit communication data; and
transmitting the communication data in accordance with the selected protocol.

8. The communication method as recited in claim 7, further comprising the steps of:
detecting real-time data to be transmitted to the receiving-side communication device, and
wherein the selecting step selects the relay protocol when the real-time data is not detected, and selects the direct protocol when the real-time data is detected.

9. The communication method as recited in claim 7, further comprising the steps of:
acquiring a communication bandwidth of the communication data;
calculating a total communication bandwidth required upon transmitting the communication data in accordance with the relay protocol on the basis of the acquired communication bandwidth of the communication data; and
determining whether or not the total communication bandwidth satisfies a condition that defines a state in which the total communication bandwidth exceeds an allowable communication bandwidth of a network used to transmit the communication data, and
wherein the selecting step selects the relay protocol when the condition is not satisfied, and selects the direct protocol when the condition is satisfied.

10. The communication method as recited in claim 7, further comprising:
a first acquisition step which acquires an allowable communication bandwidth to a control station based on the relay protocol;
a second acquisition step which acquires an allowable communication bandwidth from the control station to the receiving-side communication device based on the relay protocol; and
a step of determining whether or not the communication bandwidth of the communication data satisfies a first condition that defines a state in which the communication bandwidth exceeds the allowable communication bandwidth to the control station, and whether or not the communication bandwidth of the communication data satisfies a second condition that defines a state in which the communication bandwidth exceeds the allowable communication bandwidth from the control station to the receiving-side communication device, and
wherein the selecting step of selects the relay unit when neither of the first and second conditions are satisfied, and selects the direct protocol when at least one of the first and second conditions is satisfied.

11. The communication method as recited in claim 7, further comprising the steps of:
acquiring a communication bandwidth of the communication data;
acquiring an allowable communication bandwidth based on the direct protocol; and
determining whether or not the communication bandwidth of the communication data satisfies a condition that defines a state in which the communication bandwidth exceeds the allowable communication bandwidth based on the direct protocol, and wherein the selecting step selects the direct protocol when the condition is not satisfied, and selects the relay protocol when the condition is satisfied.

12. A computer readable recording medium that records a program, said program when executed by a computer causing the computer to execute the steps of:
selecting one of a relay protocol designed to transmit communication data to a receiving-side communication device via a control station, and a direct protocol designed to directly transmit the communication data to the receiving-side communication device, in accordance with a condition that defines a state wherein a total communication bandwidth used to transmit the communication data does not exceed an allowable communication bandwidth used to transmit communication data; and
transmitting the communication data in accordance with the selected protocol.

13. The computer readable recording medium as recited in claim 12, wherein said computer is operable for:
detecting real-time data to be transmitted to the receiving-side communication device, and
wherein the selecting step selects the relay protocol when the real-time data is not detected, and selects the direct protocol when the real-time data is detected.

14. The computer readable recording medium as recited in claim 12, wherein said computer is operable for:
acquiring a communication bandwidth of the communication data;
calculating a total communication bandwidth required upon transmitting the communication data in accordance with the relay protocol on the basis of the acquired communication bandwidth of the communication data; and
determining whether or not the total communication bandwidth satisfies a condition that defines a state in which the total communication bandwidth exceeds an allowable communication bandwidth of a network used to transmit the communication data, and
wherein the selecting step selects the relay protocol when the condition is not satisfied, and selects the direct protocol when the condition is satisfied.

15. The computer readable recording medium as recited in claim 12, wherein said computer is operable to perform:
a first acquisition step which acquires an allowable communication bandwidth to a control station based on the relay protocol;
a second acquisition step which acquires an allowable communication bandwidth from the control station to the receiving-side communication device based on the relay protocol; and
a step of determining determining whether or not the communication bandwidth of the communication data satisfies a first condition that defines a state in which the communication bandwidth exceeds the allowable communication bandwidth to the control station, and whether or not the communication bandwidth of the communication data satisfies a second condition that defines a state in which the communication bandwidth exceeds the allowable communication bandwidth from the control station to the receiving-side communication device, and
wherein the selecting step of selects the relay unit when neither of the first and second conditions are satisfied, and selects the direct protocol when at least one of the first and second conditions is satisfied.

16. The computer readable recording medium as recited in claim 12, wherein said computer is operable for:
acquiring a communication bandwidth of the communication data;
acquiring an allowable communication bandwidth based on the direct protocol; and
determining whether or not the communication bandwidth of the communication data satisfies a condition that defines a state in which the communication bandwidth exceeds the allowable communication bandwidth based on the direct protocol, and
wherein the selecting step selects the direct protocol when the condition is not satisfied, and selects the relay protocol when the condition is satisfied.
